(19) United States
(12) Patent Application Publication
(10) Pub. No.: US 2023/0275510 A1
(43) Pub. Date: Aug. 31, 2023

(54) INITIAL CHARGING DEVICE AND METHOD OF MODULAR MULTI-LEVEL CONVERTER

(71) Applicant: HYOSUNG HEAVY INDUSTRIES CORPORATION, Seoul (KR)

(72) Inventors: Dong Min CHOI, Suwon-si Gyeonggi-do (KR); Jung Won HONG, Suwon-si Gyeonggi-do (KR)

(21) Appl. No.: 18/002,945

(22) PCT Filed: Nov. 19, 2021
(86) PCT No.: PCT/KR2021/017113

§ 371 Date: Dec. 22, 2022

(30) Foreign Application Priority Data
Dec. 8, 2020 (KR) 10-2020-0170859

(51) Int. Cl. H02M 3/158; H02M 1/08; H02J 7/00

(52) U.S. Cl. CPC H02M 3/158; H02M 1/08; H02J 7/0068; H02J 2207/20

(57) ABSTRACT

The present invention relates to a first-cycle charging device and method of a modular multi-level converter, in which, in order to prevent the overcharging of a capacitor in a submodule in a HVDC system, charging and discharging of the capacitor in the submodule are independently carried out, and charging of the submodule in the HVDC system is enabled to be gradually carried out so as to prevent sudden flow of an instantaneous current. The first-cycle charging device of the modular multi-level converter of the present invention comprises: a submodule provided with a capacitor so as to carry out alternating current power charging and discharging; and a submodule control unit for controlling the charging, discharging, and bypassing of the submodule.

### FIELD OF THE INVENTION

The present invention relates to initial charging device and method of a modular multi-level converter (MMC) and, most particularly, to a function that charges a capacitor located within a sub-module of a high voltage direct current (HVDC) system, which is configured of a modular multi-level converter. That is, the present invention relates to initial charging device and method of a modular multi-level converter that can stably operate a HVDC system by controlling initial charging of a sub-module in a HVDC system, which is configured of a modular multi-level converter.

### BACKGROUND ART

Recently, attention has been rising in a method of connecting power grids by converting alternating current (AC) power to direct current (DC) power rather than a method of directly connecting direct current (DC) power grids in order to connect power grids to one another.

A high voltage direct current (HVDC) system is a system that converts an alternating current (AC) generated from a power generator to a direct current (DC), so as to transfer (or transmit) the direct current to where it is needed, and then converts the direct current back to an alternating current, which is then supplied to consumers. Recently, the HVDC system has evolved by being configured of multiple modular converters, wherein a plurality of small capacity sub-modules are connected in series.

At this point, in the HVDC system, a capacitor that is used in a direct current link is mostly used for the purpose of voltage connection and voltage smoothing of DC energy, and for the purpose of full-charging of charging/discharging energy. However, the increase in the usage of such capacitor may result in critical situations where a failure or accident, such as spurts of electrolytes caused by deterioration and temperature elevation, leads to a short circuit in the HVDC system. And, accordingly, research on such trouble-shooting has been carried out consistently.

As an example, the Korean Patent Application Publication No. 10-2017-0038510 proposed a device and method for controlling initial charging of an asymmetrical modular multi-level converter that sequentially controls different reference voltage values in half-bridge sub-modules (HB-SM) having high voltage allocated thereto to full-bridge sub-modules (FB-SM) having low voltage allocated thereto.

However, in this case also, the disadvantage is that, by performing charging according to a predetermined charging order per sub-module arm, due to the different charging voltages in a capacitor per sub-module, the duration (or life-span) of capacitors may be reduced.

### DETAILED DESCRIPTION OF THE INVENTION

### Technical Objects

An object of the present invention is to provide initial charging device and method of a modular multi-level converter that can independently perform charging and discharging of a capacitor within a sub-module, so that the capacitor within a sub-module of an HVDC system is not overcharged.

Another object of the present invention is to provide initial charging device and method of a modular multi-level converter that can gradually carry out the charging of the sub-module in a HVDC system, so as to prevent a sudden flow of instantaneous current from occurring.

### Technical Solutions

An initial charging device of a modular multi-level converter, according to the present invention may include a sub-module being equipped with a capacitor and performing charging and discharging of an alternating current power, and a sub-module control unit controlling charging, discharging, and bypassing of the sub-module.

At this point, the sub-module control unit may control the sub-module to an on state, an off state, and a block state, so as to sequentially perform a passive charge mode, an active charge mode, and a normal operation mode, thereby initializing the sub-module.

Additionally, in the passive charge mode, the sub-module control unit may control the sub-module to a block state and performs only charging of all sub-modules configured in an arm, in the active charge mode, the sub-module control unit controls the sub-module to an off state and a block state and performs charging of only part of the sub-modules configured in the arm, and, in the normal operation mode, the sub-module control unit controls the sub-module to an on state and an off state and independently performs charging and discharging of the sub-module.

Herein, the sub-module may include a capacitor storing the alternating current power, a first diode providing a charging path to the capacitor, an IGBT1 providing a discharging path of the capacitor by the control of the sub-module control unit, a second diode providing a bypassing path of the sub-module, and an IGBT2 providing the bypassing path of the sub-module by the control of the sub-module control unit.

Additionally, in the on state, the sub-module control unit may control the IGBT1 to ‘on’ and the IGBT2 to ‘off’, and, during a section where a ‘P’ input voltage of the sub-module is higher than an ‘N’ input voltage, the input voltage of the sub-module may be stored in the capacitor through the first diode, and, during a section where a ‘P’ input voltage of the sub-module is lower than an ‘N’ input voltage, the power being stored in the capacitor may be discharged due to an input of the sub-module.

Herein, in the off state, the sub-module control unit may control the IGBT1 to ‘off’ and the IGBT2 to ‘on’, thereby bypassing a ‘P’ input voltage and an ‘N’ input voltage of the sub-module.

Herein, in the block state, the sub-module control unit may control both the IGBT1 and the IGBT2 to ‘off’, and, during a section where a ‘P’ input voltage of the sub-module is higher than an ‘N’ input voltage, the input voltage of the sub-module may be stored in the capacitor through the first diode, and, during a section where a ‘P’ input voltage of the sub-module is lower than an ‘N’ input voltage, the ‘P’ input voltage and the ‘N’ input voltage may be bypassed.

Herein, in the active charge mode, voltages charged in at least two sub-modules being configured in an arm may be compared, so as to perform bypassing in an order starting from a highest level of charged voltage.

Additionally, the bypassing may be performed by comparing a carrier signal with a reference signal, the carrier signal being autonomously generated by the sub-module control unit, and by generating a number of charged sub-modules, the number of charged sub-modules being a number of sub-modules performing charging.

According to another embodiment of the present invention, an initial charging method of a modular multi-level converter, wherein the modular multi-level converter may include a sub-module being equipped with a capacitor and performing charging and discharging of an alternating current power, and a sub-module control unit controlling charging, discharging, and bypassing of the sub-module, and wherein the sub-module may include a capacitor storing the alternating current power, a first diode providing a charging path to the capacitor, an IGBT1 providing a discharging path of the capacitor by the control of the sub-module control unit, a second diode providing a bypassing path of the sub-module, and an IGBT2 providing the bypassing path of the sub-module by the control of the sub-module control unit, may include a passive charging step, wherein the sub-module control unit controls the sub-module to a block state and performs only charging of all sub-modules configured in an arm, an active charging step, wherein the sub-module control unit controls the sub-module to an off state and a block state and performs charging of only part of the sub-modules configured in the arm, and a normal operating step, wherein the sub-module control unit controls the sub-module to an on state and an off state and independently performs charging and discharging of the sub-module.

At this point, in the on state, the sub-module control unit may control the IGBT1 to ‘on’ and the IGBT2 to ‘off’, and, during a section where a ‘P’ input voltage of the sub-module is higher than an ‘N’ input voltage, the input voltage of the sub-module may be stored in the capacitor through the first diode, and, during a section where a ‘P’ input voltage of the sub-module is lower than an ‘N’ input voltage, the power being stored in the capacitor may be discharged due to an input of the sub-module.

Additionally, in the off state, the sub-module control unit may control the IGBT1 to ‘off’ and the IGBT2 to ‘on’, thereby bypassing a ‘P’ input voltage and an ‘N’ input voltage of the sub-module.

Meanwhile, in the block state, the sub-module control unit may control both the IGBT1 and the IGBT2 to ‘off’, and, during a section where a ‘P’ input voltage of the sub-module is higher than an ‘N’ input voltage, the input voltage of the sub-module may be stored in the capacitor through the first diode, and, during a section where a ‘P’ input voltage of the sub-module is lower than an ‘N’ input voltage, the ‘P’ input voltage and the ‘N’ input voltage may be bypassed.

According to yet another embodiment of the present invention, an initial charging device of a modular multi-level converter may include a first upper sub-module arm, a first lower sub-module arm, a second upper sub-module arm, and a second lower sub-module arm including a sub-module being equipped with a capacitor and performing charging and discharging of an alternating current power, and a sub-module control unit controlling charging, discharging, and bypassing of the sub-module within the first upper sub-module arm and the first lower sub-module arm,

wherein the sub-module control unit may be capable of being operated in a passive charge mode controlling the sub-module to a block state and performing only charging of all sub-modules, a first active charge mode controlling the sub-module within the first upper sub-module arm and the first lower sub-module arm to an off state and a block state and performing charging of only part of the sub-modules within the first upper sub-module arm and the first lower sub-module arm, a first normal operation mode controlling the sub-module within the first upper sub-module arm and the first lower sub-module arm to an on state and an off state and independently performing charging and discharging of the sub-module within the first upper sub-module arm and the first lower sub-module arm, a second active charge mode controlling the sub-module within the second upper sub-module arm and the second lower sub-module arm to an off state and a block state and performing charging of only part of the sub-modules within the second upper sub-module arm and the second lower sub-module arm, and a second normal operation mode controlling the sub-module within the second upper sub-module arm and the second lower sub-module arm to an on state and an off state and independently performing charging and discharging of the sub-module within the second upper sub-module arm and the second lower sub-module arm.

### Effects of the Invention

The initial charging device and method of a modular multi-level converter according to the present invention have the advantage of independently performing charging and discharging of a capacitor within a sub-module, so that the capacitor within a sub-module of an HVDC system is not overcharged.

Additionally, the initial charging device and method of a modular multi-level converter according to the present invention have the advantage of gradually carrying out the charging of the sub-module in a HVDC system, so as to prevent a sudden flow of instantaneous current from occurring.

### BRIEF DESCRIPTION OF THE DRAWINGS

FIG. 1 is a block diagram showing an initial charging device of a modular multi-level converter of the present invention.

FIG. 2 is a block diagram showing a detailed view of a sub-module of FIG. 1.

FIGS. 3(a) and 3(b) are circuit diagrams showing a detailed view of an operation state when the sub-module of FIG. 1 is in an ‘on’ state, wherein FIG. 3(a) shows a case where a P voltage is higher than an N voltage, and wherein FIG. 3(b) shows a case where the P voltage is lower than the N voltage.

FIGS. 4(a) and 3(b) are circuit diagrams showing a detailed view of an operation state when the sub-module of FIG. 1 is in an ‘off’ state, wherein FIG. 4(a) shows a case where a P voltage is higher than an N voltage, and wherein FIG. 4(b) shows a case where the P voltage is lower than the N voltage.

FIG. 5 is a circuit diagram showing a detailed view of an operation state when the sub-module of FIG. 1 is in a ‘block’ state, wherein FIG. 5(a) shows a case where a P voltage is higher than an N voltage, and wherein FIG. 5(b) shows a case where the P voltage is lower than the N voltage.

FIGS. 6(a) and 3(b) are detailed graphs showing a number of sub-modules of FIG. 1 that are being charged, wherein FIG. 6(a) is a diagram simultaneously showing a carrier signal and a reference signal, and wherein FIG. 6(b) is a diagram showing a number of sub-modules that are being charged.

FIG. 7 is a detailed graph showing voltage being output from the sub-module of FIG. 1, wherein FIG. 7(a) shows a case where the number of sub-modules that are being charged is fixed without performing any comparison between a carrier signal and a reference signal in the active charging mode, and wherein FIG. 7(b) shows a case where the active charging mode is performed, wherein the number of sub-modules being charged is changed so that the voltage of the sub-modules can be gradually increased through a comparison between a carrier signal and a reference signal in the active charging mode.

FIG. 8 is a flow chart showing an initial charging method of a modular multi-level converter according to an embodiment of the present invention.

FIG. 9 is a block diagram showing an initial charging device of a modular multi-level converter according to another embodiment of the present invention.

FIG. 10 is a flow chart showing an initial charging method of a modular multi-level converter according to another embodiment of the present invention.

### MODE FOR CARRYING OUT THE INVENTION

A detailed embodiment for carrying out the present invention will be described with reference to the appended drawings.

Various modifications and variations can be made in the present invention, and the present invention may have various embodiments. Therefore, examples of specific embodiments will be illustrated in the drawings and described in detail in the detailed description of the present invention. This is not intended to limit the present invention only to a specific form of embodiment. And, thus, it may be understood that the embodiments include all modifications and variations, equivalents and substitutions of the invention provided that they come within the spirit and technical scope of the present invention.

Hereinafter, initial charging method and device of a modular multi-level converter according to the present invention will be described in detail with reference to the appended drawings.

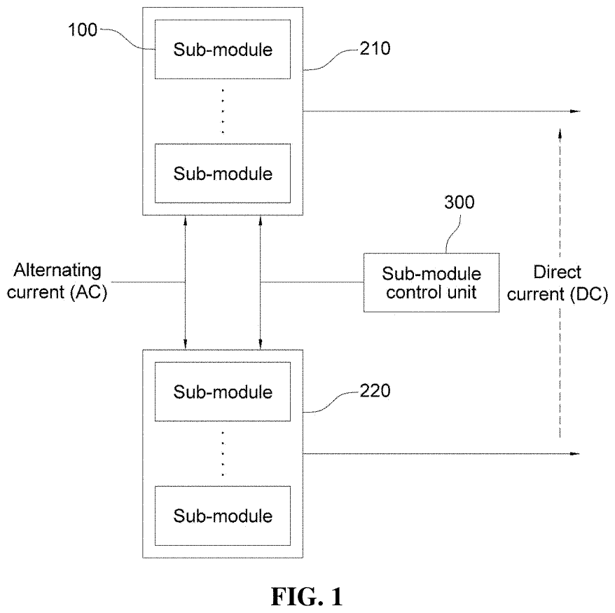

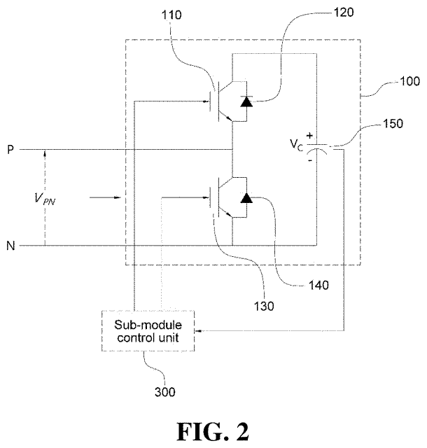

FIG. 1 is a block diagram showing an initial charging device of a modular multi-level converter of the present invention, and FIG. 2 to FIG. 7 are detailed block diagrams and diagrams for describing FIG. 1 in more detail.

Hereinafter, the initial charging device of a modular multi-level converter according to an embodiment of the present invention will be described with reference to FIG. 1 to FIG. 7.

Firstly, referring to FIG. 1, an initial charging device of a modular multi-level converter according to an embodiment of the present invention may be configured of a sub-module 100 that is equipped with a capacitor and performs charging and discharging of an alternating current power, and a sub-module control unit 300 that controls charging, discharging, and bypassing of the sub-module 100.

Herein, the sub-module control unit 300 controls the sub-module to an on state, an off state, and a block state, so as to sequentially perform a passive charge mode, an active charge mode, and a normal operation mode, thereby initializing the sub-module 100.

Additionally, in the passive charge mode, the sub-module control unit 300 controls the sub-module 100 to a block state and performs only charging of all sub-modules 100 configured in an arm, and, in the active charge mode, the sub-module control unit 300 controls the sub-module 100 to an off state and a block state and performs charging of only part (or some) of the sub-modules 100 configured in the arm, and, in the normal operation mode, the sub-module control unit 300 controls the sub-module 100 to an on state and an off state and independently performs charging and discharging of the sub-module 100.

That is, at the beginning of the charging, the sub-module control unit 300 controls the sub-module 100 to a block state so as to operate an upper sub-module arm 210 and a lower sub-module arm 220 in a passive charging mode, thereby performing charging of all sub-modules 100. At this point, since the charging is carried out at a charging voltage of the sub-module 100 that is only half of a target value, the charging needs to be carried out by bypassing part of the sub-modules 100.

At this point, the sub-module control unit 300 may interchangeably use the off state and the block state of the sub-module 100 so as to operate the upper sub-module arm 210 and the lower sub-module arm 220 in an active charging mode, thereby performing charging by bypassing part (or some) of the sub-modules 100. In this case also, since the charging voltage of the sub-module 100 does not reach its target value, a charging mode that discharges the voltage of the sub-module 100 and then recharges the sub-module 100 is needed.

Therefore, by interchangeably using the on state and the off state of the sub-module 100 so as to operate the upper sub-module arm 210 and the lower sub-module arm 220 in a normal operation mode, the sub-module control unit 300 of the present invention may repeat the charging and discharging of the sub-module 100 so that the charging voltage can reach the target value. That is, by sequentially controlling the passive charging mode, the active charging mode, and the normal operation mode of the sub-module 100, the sub-module control unit 300 of the present invention may stably initialize the voltage of the sub-module 100.

FIG. 2 is a block diagram showing a detailed view of a sub-module 100 of FIG. 1.

As shown in FIG. 2, the sub-module 100 of the present invention is equipped with a capacitor 150 storing the current power, a first diode 120 providing a charging path to the capacitor 150, an IGBT1 110 providing the discharging path of the capacitor 150 by the control of the sub-module control unit 300, a second diode 140 providing a bypassing path of the sub-module 100, and an IGBT2 130 providing the bypassing path of the sub-module 100 by the control of the sub-module control unit 300.

Meanwhile, in the present invention, when an input P voltage of the sub-module 100 is lower than an input N voltage, if the IGBT1 110 provides a discharging path due to the control of the sub-module control unit 300, discharging may be performed. However, if the discharging path is not provided due to the control of the sub-module control unit 300, bypassing is allowed by the second diode 140.

Additionally, when the input P voltage of the sub-module 100 is higher than an input N voltage, if the IGBT2 130 provides a bypassing path due to the control of the sub-module control unit 300, bypassing may be performed. However, if the bypassing path is not provided due to the control of the sub-module control unit 300, the charging is performed in the capacitor 150 due to the first diode 120 path.

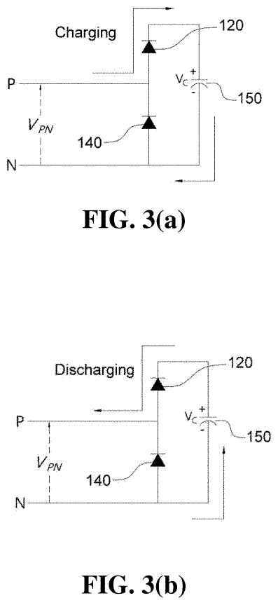

Such operation of the present invention may be divided into an on state, wherein the IGBT1 110 is controlled to be ‘on’ and the IGBT2 130 is controlled to be ‘off’ so that charging and discharging are independently performed, an off state, wherein the IGBT1 110 is controlled to be ‘off’ and the IGBT2 130 is controlled to be ‘on’ so that only bypassing is performed, and a block state, wherein both the IGBT1 110 and the IGBT2 130 are controlled to be ‘off’ so that only charging is performed. And, each operation state will be described in detail based on FIGS. 3(a) and 3(b) to FIG. 5, respectively.

FIGS. 3(a) and 3(b) are circuit diagrams showing a detailed view of an operation state when the sub-module 100 of FIG. 1 is in an ‘on’ state, wherein FIG. 3(a) shows a case where a P voltage is higher than an N voltage, and wherein FIG. 3(b) shows a case where the P voltage is lower than the N voltage.

As shown in FIGS. 3(a) and 3(b), according to the present invention, in the on state, the sub-module control unit 300 controls the IGBT1 110 to be ‘on’ and the IGBT2 130 to be ‘off’.

And, during a section where a ‘P’ input voltage of the sub-module 100 is higher than an ‘N’ input voltage, the input power of the sub-module 100 is stored in the capacitor 150 through the first diode 120. And, during a section where the ‘P’ input voltage is lower than the ‘N’ input voltage, the power stored in the capacitor 150 may be discharged due to an input of the sub-module 100.

Thus, the one state may also allow the voltage of the sub-module 100 to reach a target value in a normal mode.

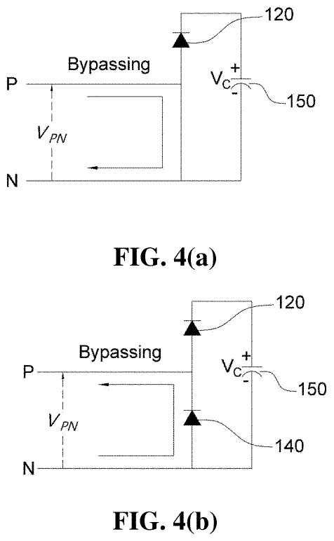

FIGS. 4(a) and 3(b) are circuit diagrams showing a detailed view of an operation state when the sub-module 100 of FIG. 1 is in an ‘off’ state, wherein FIG. 4(a) shows a case where a P voltage is higher than an N voltage, and wherein FIG. 4(b) shows a case where the P voltage is lower than the N voltage.

As shown in FIGS. 4(a) and 3(b), according to the present invention, in the off state, the sub-module control unit 300 controls the IGBT1 110 to be ‘off’ and the IGBT2 130 to be ‘on’, thereby allowing the ‘P’ voltage and the ‘N’ voltage of the sub-module 100 to be bypassed.

Thus, along with the on state, the off state also allows the voltage of the sub-module 100 to reach the target value in the normal mode. And, in the active charging mode, the off state allows the voltage of the sub-module 100 to reach up to part of the target value, along with the block state.

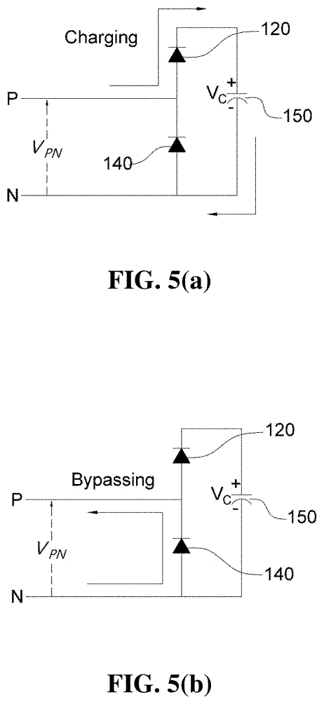

FIG. 5 is a circuit diagram showing a detailed view of an operation state when the sub-module 100 of FIG. 1 is in a ‘block’ state, wherein FIG. 5(a) shows a case where a P voltage is higher than an N voltage, and wherein FIG. 5(b) shows a case where the P voltage is lower than the N voltage.

As shown in FIG. 5, according to the present invention, in the on state, the sub-module control unit 300 controls both the IGBT1 110 and the IGBT2 130 to be ‘off’. And, during a section where the ‘P’ input voltage of the sub-module 100 is higher than the ‘N’ input voltage, the input power of the sub-module 100 is stored in the capacitor 150 through the first diode 120. And, during a section where the ‘P’ input voltage is lower than the ‘N’ input voltage, the ‘P’ input and the ‘N’ input are bypassed.

Thus, the block state may allow the voltage of the sub-module 100 to reach half of the target value, in the passive charging mode.

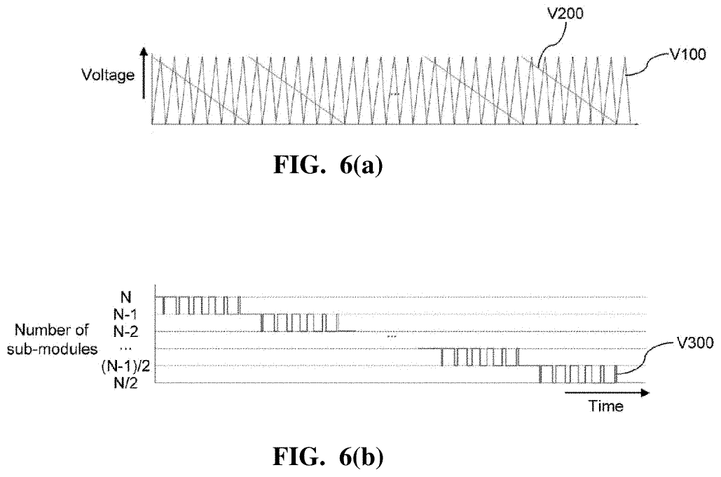

FIGS. 6(a) and 3(b) are detailed graphs showing a number of sub-modules 100 of FIG. 1 that are being charged, wherein FIG. 6(a) is a diagram simultaneously showing phase V100 and a reference signal V200, and wherein FIG. 6(b) is a diagram showing phase V300.

As shown in FIGS. 6(a) and 3(b), in the present invention, the active charging mode compares voltages charged in at least two sub-modules 100 configured in an arm, so as to perform bypass in an order starting from a highest charged voltage level.

Such bypassing may be performed by comparing a carrier signal V100, which is autonomously generated in the sub-module control unit 300, with a reference signal V200, and by generating a number of charged sub-modules V300, which is a number of sub-modules 100 performing charging. Herein, the carrier signal V100 may use a triangular wave, and this has an advantage of facilitating implementation to hardware, as compared to a method using a sine function.

Additionally, the reference signal V200 may use a sawtooth wave, and the bypassing control of one sub-module 100 may be independently performed per sawtooth wave.

Thus, by controlling only one sub-module 100 instead of controlling all sub-modules 100, the voltage of a sub-module 100 may be gradually increased.

Depending upon the implementation, the charged voltages are sorted in a descending order starting from the highest level, so as to decide the bypassing order. And, the sorting may be re-performed only when the voltage charged to the capacitor 150 has a difference that is equal to or greater than a predetermined value.

At this point, by allowing the sorting to be re-performed based on the predetermined value, the sorting period (or cycle) may be extended, thereby reducing a number of switches of the IGBT2 130 and reducing loss of the IGBT2 130.

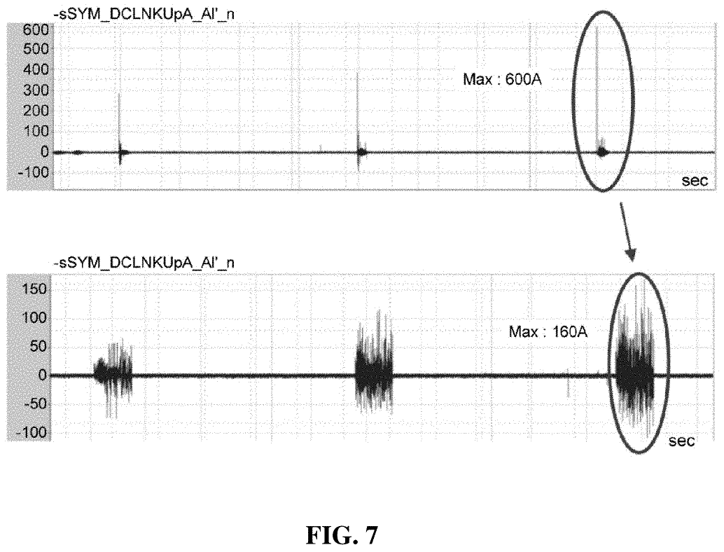

FIG. 7 is a detailed graph showing voltage being output from the sub-module of FIG. 1, wherein FIG. 7(a) shows a case where the number of sub-modules that are being charged is fixed without performing any comparison between a carrier signal and a reference signal in the active charging mode, and wherein FIG. 7(b) shows a case where the active charging mode is performed, wherein the number of sub-modules being charged is changed so that the voltage of the sub-modules can be gradually increased through a comparison between a carrier signal and a reference signal in the active charging mode. As shown in FIG. 7, in case the proposed method is not applied, a very high level of direct current power C100 may be generated.

As described above, by controlling the voltage being charged to the IGBT1 110 to be gradually increased in the active charging mode, which is positioned between the passive charging mode and the normal operation mode, the initial charging device of a modular multi-level converter according to the present invention may reduce a peak current of the direct current C100.

FIG. 8 is a flow chart showing an initial charging method of a modular multi-level converter according to an embodiment of the present invention.

As shown in FIG. 8, the initial charging method of the modular multi-level converter according to the present invention includes a passive charging step (S100), wherein the sub-module control unit 300 controls the sub-module 100 to a block state and performs only charging of all sub-modules 100 configured in an arm, an active charging step (S200), wherein the sub-module control unit 300 controls the sub-module 100 to an off state and a block state and performs charging of only part of the sub-modules 100 configured in the arm, and a normal operating step (S300), wherein the sub-module control unit 300 controls the sub-module 100 to an on state and an off state and independently performs charging and discharging of the sub-module 100.

Herein, in the on state, the sub-module control unit 300 controls the IGBT1 110 to be ‘on’ and the IGBT2 130 to be ‘off’. And, during a section where a ‘P’ input voltage of the sub-module 100 is higher than an ‘N’ input voltage, the input power of the sub-module 100 is stored in the capacitor 150 through the first diode 120. And, during a section where the ‘P’ input voltage is lower than the ‘N’ input voltage, the power stored in the capacitor 150 is discharged due to an input of the sub-module 100.

Additionally, in the off state, the sub-module control unit 300 controls the IGBT1 110 to be ‘off’ and the IGBT2 130 to be ‘on’, thereby allowing the ‘P’ voltage and the ‘N’ voltage of the sub-module 100 to be bypassed.

Meanwhile, in the on state, the sub-module control unit 300 controls both the IGBT1 110 and the IGBT2 130 to be ‘off’. And, during a section where the ‘P’ input voltage of the sub-module 100 is higher than the ‘N’ input voltage, the input power of the sub-module 100 is stored in the capacitor 150 through the first diode 120. And, during a section where the ‘P’ input voltage is lower than the ‘N’ input voltage, the ‘P’ input and the ‘N’ input are bypassed.

That is, in the present invention, at the beginning of the charging, during the passive charging step (S100), the sub-module control unit 300 controls the sub-module 100 to a block state so as to operate an upper sub-module arm 210 and a lower sub-module arm 220 in the passive charging step (S100), thereby performing charging of all sub-modules 100. At this point, since the charging is carried out at a charging voltage of the sub-module 100 that is only half of a target value, the charging needs to be carried out by bypassing part of the sub-modules 100.

At this point, in the active charging step (S200), the sub-module control unit 300 may interchangeably use the off state and the block state of the sub-module 100 so as to operate the upper sub-module arm 210 and the lower sub-module arm 220 in the active charging step (S200), thereby performing charging by bypassing part (or some) of the sub-modules 100. In this case also, since the charging voltage of the sub-module 100 does not reach its target value, a charging mode that discharges the voltage of the sub-module 100 and then recharges the sub-module 100 is needed.

Therefore, in the normal operating step (S300), by interchangeably using the on state and the off state of the sub-module 100 so as to operate the upper sub-module arm 210 and the lower sub-module arm 220 in the normal operating step (S300), the sub-module control unit 300 of the present invention may repeat the charging and discharging of the sub-module 100 so that the charging voltage can reach the target value.

That is, by sequentially controlling the passive charging mode, the active charging mode, and the normal operation mode of the sub-module 100, the sub-module control unit 300 of the present invention has the advantage of being capable of stably initializing the voltage of the sub-module 100.

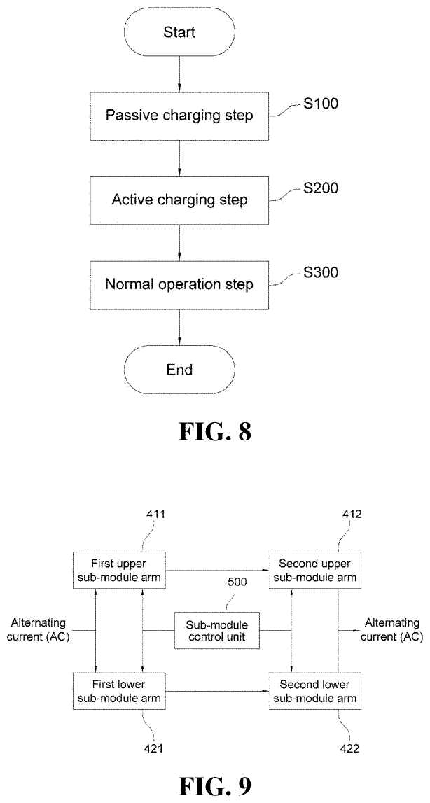

FIG. 9 is a block diagram showing an initial charging device of a modular multi-level converter according to another embodiment of the present invention.

As shown in FIG. 9, the initial charging device of a modular multi-level converter according to another embodiment of the present invention includes a first upper sub-module arm 411, a first lower sub-module arm 421, a second upper sub-module arm 412, and a second lower sub-module arm 422 including a sub-module 100 being equipped with a capacitor and performing charging and discharging of an alternating current power, and a sub-module control unit 500 controlling charging, discharging, and bypassing of the sub-module 100 within the first upper sub-module arm 411 and the first lower sub-module arm 421.

At this point, the sub-module control unit 500 is capable of being operated in a passive charge mode controlling the sub-module 100 to a block state and performing only charging of all sub-modules 100, a first active charge mode controlling the sub-module 100 within the first upper sub-module arm 411 and the first lower sub-module arm 421 to an off state and a block state and performing charging of only part of the sub-modules 100 within the first upper sub-module arm 411 and the first lower sub-module arm 421, a first normal operation mode controlling the sub-module 100 within the first upper sub-module arm 411 and the first lower sub-module arm 421 to an on state and an off state and independently performing charging and discharging of the sub-module 100 within the first upper sub-module arm 421 and the first lower sub-module arm 411, a second active charge mode controlling the sub-module 100 within the second upper sub-module arm 412 and the second lower sub-module arm 422 to an off state and a block state and performing charging of only part of the sub-modules 100 within the second upper sub-module arm 412 and the second lower sub-module arm 422, and a second normal operation mode controlling the sub-module 100 within the second upper sub-module arm 412 and the second lower sub-module arm 422 to an on state and an off state and independently performing charging and discharging of the sub-module 100 within the second upper sub-module arm 412 and the second lower sub-module arm 422.

That is, according to the present embodiment, at the beginning of the charging, the sub-module control unit 500 controls the sub-module 100 to a block state so as to operate a first upper sub-module arm 411, a first lower sub-module arm 421, a second upper sub-module arm 412, and a second lower sub-module arm 422 in a passive charging mode, thereby performing charging of all sub-modules 100. At this point, since the charging is carried out at a charging voltage of the sub-module 100 that is only half of a target value, the charging needs to be carried out by bypassing part (or some) of the sub-modules 100.

At this point, the sub-module control unit 500 may interchangeably use the off state and the block state of the sub-module 100 so as to operate the first upper sub-module arm 411 and the first lower sub-module arm 421 in an active charging mode, thereby performing charging by bypassing part (or some) of the sub-modules 100 of the first upper sub-module arm 411 and the first lower sub-module arm 421. In this case also, since the charging voltage of the sub-module 100 does not reach its target value, a charging mode that discharges the voltage of the sub-module 100 and then recharges the sub-module 100 is needed.

Therefore, by interchangeably using the on state and the off state of the sub-module 100 so as to operate the first upper sub-module arm 411 and the first lower sub-module arm 421 in a normal operation mode, the sub-module control unit 500 may repeat the charging and discharging of the sub-module 100 so that the charging voltage can reach the target value.

Meanwhile, the sub-module control unit 500 according to the present embodiment may interchangeably use the off state and the block state of the sub-module 100 so as to operate the second upper sub-module arm 412 and the second lower sub-module arm 422 in an active charging mode, thereby performing charging by bypassing part (or some) of the sub-modules 100 of the second upper sub-module arm 412 and the second lower sub-module arm 422. In this case also, since the charging voltage of the sub-module 100 does not reach its target value, a charging mode that discharges the voltage of the sub-module 100 and then recharges the sub-module 100 is needed.

Therefore, by interchangeably using the on state and the off state of the sub-module 100 so as to operate the second upper sub-module arm 412 and the second lower sub-module arm 422 in a normal operation mode, the sub-module control unit 500 may repeat the charging and discharging of the sub-module 100 so that the charging voltage can reach the target value.

That is, by sequentially controlling the passive charging mode, the active charging mode, and the normal operation mode of the sub-module 100, the sub-module control unit 500 according to the present embodiment may stably initialize the voltage of the sub-module 100.

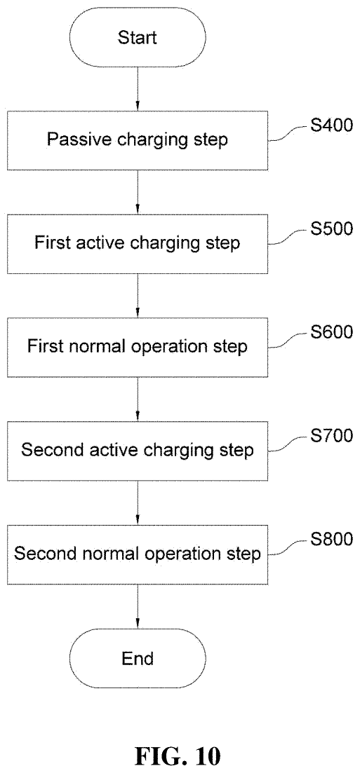

FIG. 10 is a flow chart showing an initial charging method of a modular multi-level converter according to another embodiment of the present invention.

As shown in FIG. 10, the initial charging method of the modular multi-level converter is configured of a passive charging step (S400), a first active charging step (S500), a first normal operating step (S600), a second active charging step (S700), and a second normal operating step (S800).

At this point, in the passive charging step (S400), the sub-module control unit 500 controls the sub-module 100 to a block state, thereby performing charging of all sub-modules 100.

In the first active charging step (S500), the sub-module control unit 500 controls the sub-module 100 within a first upper sub-module arm 411 and a first lower sub-module arm 421 to an off state and a block state, thereby performing charging of only part (or some) of the sub-modules 100 within the first upper sub-module arm 411 and the first lower sub-module arm 421.

In the first normal operating step (S600), the sub-module control unit 500 controls the sub-module 100 within the first upper sub-module arm 411 and the first lower sub-module arm 421 to an on state and an off state, thereby independently performing charging and discharging of the sub-module 100 within the first upper sub-module arm 411 and the first lower sub-module arm 421.

Additionally, in the second active charging step (S700), the sub-module control unit 500 controls the sub-module 100 within a second upper sub-module arm 412 and a second lower sub-module arm 422 to an off state and a block state, thereby performing charging of only part (or some) of the sub-modules 100 within the second upper sub-module arm 412 and the second lower sub-module arm 422.

Thereafter, in the second normal operating step (S800), the sub-module control unit 500 controls the sub-module 100 within the second upper sub-module arm 412 and the second lower sub-module arm 422 to an on state and an off state, thereby independently performing charging and discharging of the sub-module 100 within the second upper sub-module arm 412 and the second lower sub-module arm 422.

That is, in the present invention, at the beginning of the charging, during the passive charging step (S400), the sub-module control unit 500 controls the sub-module 100 to a block state so as to operate a first upper sub-module arm 411, a first lower sub-module arm 421, a second upper sub-module arm 412, and a second lower sub-module arm 422 in a passive charge mode, thereby performing charging of all sub-modules 100. At this point, since the charging is carried out at a charging voltage of the sub-module 100 that is only half of a target value, the charging needs to be carried out by bypassing part of the sub-modules 100.

At this point, in the first active charging step (S500), the sub-module control unit 500 may interchangeably use the off state and the block state of the sub-module 100 so as to operate the first upper sub-module arm 411 and the first lower sub-module arm 421 in an active charge mode, thereby performing charging by bypassing part (or some) of the sub-modules 100. In this case also, since the charging voltage of the sub-module 100 does not reach its target value, a charging mode that discharges the voltage of the sub-module 100 and then recharges the sub-module 100 is needed.

Therefore, in the first normal operating step (S600), by interchangeably using the on state and the off state of the sub-module 100 so as to operate the first upper sub-module arm 411 and the first lower sub-module arm 421 in a normal operation mode, the sub-module control unit 500 of the present invention may repeat the charging and discharging of the sub-module 100 so that the charging voltage can reach the target value. [98] Meanwhile, in the second active charging step (S700), the sub-module control unit 500 may interchangeably use the off state and the block state of the sub-module 100 so as to operate the second upper sub-module arm 412 and the second lower sub-module arm 422 in the active charge mode, thereby performing charging by bypassing part (or some) of the sub-modules 100.

In this case also, since the charging voltage of the sub-module 100 does not reach its target value, a charging mode that discharges the voltage of the sub-module 100 and then recharges the sub-module 100 is needed. [99] Therefore, in the second normal operating step (S800), by interchangeably using the on state and the off state of the sub-module 100 so as to operate the second upper sub-module arm 412 and the second lower sub-module arm 422 in the normal operation mode, the sub-module control unit 500 of the present invention may repeat the charging and discharging of the sub-module 100 so that the charging voltage can reach the target value.

That is, by sequentially controlling the passive charging mode, the active charging mode, and the normal operation mode of the sub-module 100, the sub-module control unit 500 may stably initialize the voltage of the sub-module 100.

As described above, the initial charging device and method of a modular multi-level converter according to the present invention have the advantage of independently performing charging and discharging of a capacitor within a sub-module, so that the capacitor within a sub-module of an HVDC system is not overcharged, and also the advantage of gradually carrying out the charging of the sub-module in a HVDC system, so as to prevent a sudden flow of instantaneous current from occurring.

The description presented above includes a practical example of one or more exemplary embodiments. Evidently, it may be acknowledged that all possible combinations of components or methods will not be described merely for the purpose of describing the above-described exemplary embodiments, and that numerous additional combinations and substitutions (or replacements) of various embodiments may be made by anyone with ordinary skills in the art. Therefore, the above-described embodiments include all alternatives, variations, and modifications that fall within the scope and spirit of the appended claims of the present invention.

### INDUSTRIAL APPLICABILITY

The present invention relates to initial charging device and method of a modular multi-level converter (MMC) and is applicable to a modular multi-level converter.

What is claimed is:

1. An initial charging device of a modular multi-level converter, comprising: a sub-module being equipped with a capacitor and performing charging and discharging of an alternating current power; and
a sub-module control unit controlling charging, discharging, and bypassing of the sub-module.

2. The initial charging device of a modular multi-level converter of claim 1, wherein the sub-module control unit controls the sub-module to an on state, an off state, and a block state, so as to sequentially perform a passive charge mode, an active charge mode, and a normal operation mode, thereby initializing the sub-module.

3. The initial charging device of a modular multi-level converter of claim 2, wherein, in the passive charge mode, the sub-module control unit controls the sub-module to a block state and performs only charging of all sub-modules configured in an arm,
wherein, in the active charge mode, the sub-module control unit controls the sub-module to an off state and a block state and performs charging of only part of the sub-modules configured in the arm, and
wherein, in the normal operation mode, the sub-module control unit controls the sub-module to an on state and an off state and independently performs charging and discharging of the sub-module.

4. The initial charging device of a modular multi-level converter of claim 1, wherein the sub-module comprises:
a capacitor storing the alternating current power;
a first diode providing a charging path to the capacitor;
an IGBT1 providing a discharging path of the capacitor by the control of the sub-module control unit;
a second diode providing a bypassing path of the sub-module; and
an IGBT2 providing the bypassing path of the sub-module by the control of the sub-module control unit.

5. The initial charging device of a modular multi-level converter of claim 4, wherein, in the on state, the sub-module control unit controls the IGBT1 to ‘on’ and the IGBT2 to ‘off’, and
wherein, during a section where a ‘P’ input voltage of the sub-module is higher than an ‘N’ input voltage, the input voltage of the sub-module is stored in the capacitor through the first diode, and, during a section where a ‘P’ input voltage of the sub-module is lower than an ‘N’ input voltage, the power being stored in the capacitor is discharged due to an input of the sub-module.

6. The initial charging device of a modular multi-level converter of claim 4, wherein, in the off state, the sub-module control unit controls the IGBT1 to ‘off’ and the IGBT2 to ‘on’, thereby bypassing a ‘P’ input voltage and an ‘N’ input voltage of the sub-module.

7. The initial charging device of a modular multi-level converter of claim 4, wherein, in the block state, the sub-module control unit controls both the IGBT1 and the IGBT2 to ‘off’, and
wherein, during a section where a ‘P’ input voltage of the sub-module is higher than an ‘N’ input voltage, the input voltage of the sub-module is stored in the capacitor through the first diode, and, during a section where a ‘P’ input voltage of the sub-module is lower than an ‘N’ input voltage, the ‘P’ input voltage and the ‘N’ input voltage are bypassed.

8. The initial charging device of a modular multi-level converter of claim 2, wherein, in the active charge mode, voltages charged in at least two sub-modules being configured in an arm are compared, so as to perform bypassing in an order starting from a highest level of charged voltage.

9. The initial charging device of a modular multi-level converter of claim 8, wherein the bypassing is performed by comparing a carrier signal with a reference signal, the carrier signal being autonomously generated by the sub-module control unit, and by generating a number of charged sub-modules, the number of charged sub-modules being a number of sub-modules performing charging.

10. An initial charging method of a modular multi-level converter, wherein the modular multi-level converter comprises:
a sub-module being equipped with a capacitor and performing charging and discharging of an alternating current power; and
a sub-module control unit controlling charging, discharging, and bypassing of the sub-module, and wherein the sub-module comprises:
a capacitor storing the alternating current power;
a first diode providing a charging path to the capacitor;
an IGBT1 providing a discharging path of the capacitor by the control of the sub-module control unit;
a second diode providing a bypassing path of the sub-module; and
an IGBT2 providing the bypassing path of the sub-module by the control of the sub-module control unit,
the initial charging method of the modular multi-level converter, comprising:
a passive charging step, wherein the sub-module control unit controls the sub-module to a block state and performs only charging of all sub-modules configured in an arm;
an active charging step, wherein the sub-module control unit controls the sub-module to an off state and a block state and performs charging of only part of the sub-modules configured in the arm; and
a normal operating step, wherein the sub-module control unit controls the sub-module to an on state and an off state and independently performs charging and discharging of the sub-module.

11. The initial charging method of a modular multi-level converter of claim 10, wherein, in the on state, the sub-module control unit controls the IGBT1 to ‘on’ and the IGBT2 to ‘off’, and
wherein, during a section where a ‘P’ input voltage of the sub-module is higher than an ‘N’ input voltage, the input voltage of the sub-module is stored in the capacitor through the first diode, and, during a section where a ‘P’ input voltage of the sub-module is lower than an ‘N’ input voltage, the power being stored in the capacitor is discharged due to an input of the sub-module.

12. The initial charging method of a modular multi-level converter of claim 10, wherein, in the off state, the sub-module control unit controls the IGBT1 to ‘off’ and the IGBT2 to ‘on’, thereby bypassing a ‘P’ input voltage and an ‘N’ input voltage of the sub-module.

13. The initial charging method of a modular multi-level converter of claim 10, wherein, in the block state, the sub-module control unit controls both the IGBT1 and the IGBT2 to ‘off’, and
wherein, during a section where a ‘P’ input voltage of the sub-module is higher than an ‘N’ input voltage, the input voltage of the sub-module is stored in the capacitor through the first diode, and, during a section where a ‘P’ input voltage of the sub-module is lower than an ‘N’ input voltage, the ‘P’ input voltage and the ‘N’ input voltage are bypassed.

14. An initial charging device of a modular multi-level converter, comprising:
a first upper sub-module arm, a first lower sub-module arm, a second upper sub-module arm, and a second lower sub-module arm including a sub-module being equipped with a capacitor and performing charging and discharging of an alternating current power; and
a sub-module control unit controlling charging, discharging, and bypassing of the sub-module within the first upper sub-module arm and the first lower sub-module arm,
wherein the sub-module control unit is capable of being operated in:
a passive charge mode controlling the sub-module to a block state and performing only charging of all sub-modules;
a first active charge mode controlling the sub-module within the first upper sub-module arm and the first lower sub-module arm to an off state and a block state and performing charging of only part of the sub-modules within the first upper sub-module arm and the first lower sub-module arm;
a first normal operation mode controlling the sub-module within the first upper sub-module arm and the first lower sub-module arm to an on state and an off state and independently performing charging and discharging of the sub-module within the first upper sub-module arm and the first lower sub-module arm;
a second active charge mode controlling the sub-module within the second upper sub-module arm and the second lower sub-module arm to an off state and a block state and performing charging of only part of the sub-modules within the second upper sub-module arm and the second lower sub-module arm; and
a second normal operation mode controlling the sub-module within the second upper sub-module arm and the second lower sub-module arm to an on state and an off state and independently performing charging and discharging of the sub-module within the second upper sub-module arm and the second lower sub-module arm.
